(19) United States
(12) Patent Application Publication
(10) Pub. No.: US 2009/0310134 A1
(43) Pub. Date: Dec. 17, 2009

(54) Multi Micro-Hollow Cathode Light Source and Multi-Atomic Simulataneous Absorption Spectrum Analyzer

(76) Inventors: Masaru Hori, Aichi (JP); Masafumi Ito, Wakayama (JP); Takayuki Ohta, Wakayama (JP); Hiroyuki Kano, Aichi-ken (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 12/225,385

(22) PCT Filed: Nov. 2, 2006
(86) PCT No.: PCT/JP2006/321995

§ 371 Date: Mar. 23, 2009

(30) Foreign Application Priority Data
Mar. 21, 2006 (JP) 2006-077889

(51) Int. Cl. H01J 61/09; G01J 3/28

(52) U.S. Cl. 356/326; 313/618

(57) ABSTRACT

[Object] To achieve a compact point light source exhibiting multielement emission spectra with which multi elements can be simultaneously analyzed.

[Solving Means] The light source includes a glass vessel 40 containing He gas; a plurality of micro hollow pipes 11 that are cylindrical with a diameter of 1 mm or less and made of copper or a copper alloy; an anode mesh 32 provided at ends of the micro hollow pipes 11 with an insulating spacer 33 between the anode mesh 32 and the ends; a metal wire 14 provided in the micro hollow pipe 11, the metal wire being made of an element corresponding to a desired light-source spectrum.

### TECHNICAL FIELD

The present invention relates to light sources that can provide simultaneous multielement light emission and are applicable to simultaneous multielement atomic absorption spectrometry; and simultaneous multielement atomic absorption spectrometers.

### BACKGROUND ART

Atomic absorption spectrometry is a technique for determining the amount of trace metal in a substance in a highly accurate manner. Atomic absorption spectrometry provides highly quantitative analysis and involves only low interference. Apparatuses using the technique are desirably of small size and portable. Existing hollow cathode emission tubes are used as light sources for atomic absorption spectrometry. Such a hollow cathode emission tube provides a resonance line of a metal forming the cathode by cathode sputtering, providing a spectrum unique to an element to be analyzed. However, such a tube has a diameter as large as about several centimeters. For each of metals to be analyzed, a single tube providing light with a spectrum corresponding to a metal is typically required.

Thus, simultaneous analysis of several metals requires several tubes, causing a problem of size increase in the apparatuses. To solve the problem, a micro hollow cathode emission tube has been suggested that emits light through the hollow portion thereof with a hollow diameter of 0.1 mm at a relatively high buffer gas pressure. However, such a tube does not provide the sputtering phenomenon sufficient to cause a metal forming the cathode to emit light. Thus, the tube has a problem in that it is difficult to use as a light source of a metal element.

To solve the problem, Patent Document 1 below discloses a micro hollow light source facilitating generation of metal plasma by irradiating a metal in the light source with a laser to vaporize the metal.
[Patent Document 1] Japanese Unexamined Patent Application Publication No. 2005-300345

### DISCLOSURE OF INVENTION

### Problems to be Solved by the Invention

However, Patent Document 1 requires use of a laser, causing a problem of size increase in the light source. Thus, even when a micro hollow cathode is used, generation of high density plasma has not been easy and confinement and stable generation of high density plasma have been difficult.

The inventor of the present invention has focused attention on such a problem and has found that high density plasma can be confined in a pipe with a configuration where the pipe, which is made of copper or a copper alloy and has an inner diameter of 0.05 to 1 cm, as a cathode, and an anode are enclosed in a helium (He) gas-filled transparent vessel such that the opening of the pipe faces the anode. That is, the inventor has found that use of a pipe made of copper or a copper alloy increases sputtering efficiency; enclosure with He gas increases the efficiency of secondary electron emission; and hence high density plasma can be confined in the pipe made of copper or a copper alloy.

For the purpose of confining high density plasma and obtaining different emission spectra, the inventor has conceived that placement of another metal material for providing another desired emission spectrum in the pipe permits multielement light emission.

The inventors of the present invention have also conceived that multi light emission with desired spectra is obtained by stacking an anode plate, an insulating plate, and a cathode plate made of copper or a copper alloy; forming a plurality of holes with a diameter of 1 cm or less extending through the cathode plate, the insulating plate, and the anode plate; and disposing metal plates that provide desired emission spectra at openings of the holes of the cathode plate, whereby high density plasma is confined in the holes and the openings of the holes.

In summary, an object of the present invention is to provide a light source with multielement light emission spectra with which simultaneous multielement analysis can be performed.

### Means for Solving the Problems

To solve the problems, an invention according to Claim 1 provides a multi micro hollow cathode light source that generates micro hollow plasma as a light source in atmospheric gas, including a plurality of cylindrical micro hollow pipes with a diameter of 1 cm or less that are made of a metal having a high secondary electron emission coefficient such as copper or a copper alloy; an anode plate provided at ends of the micro hollow pipes with an insulating member between the anode plate and the ends; a metal material provided in the micro hollow pipe, the metal material being made of an element corresponding to a desired light-source spectrum; and atmospheric gas.

Examples of a base material for the pipes include copper and copper alloys. Copper and copper alloys are desirable because of their availability at low cost, high thermal conductivity, and high secondary electron emission coefficients. Alternatively, other metals having high secondary electron emission coefficients may be used as materials for the pipes. For example, a metal having a secondary electron emission coefficient of preferably 0.2 or more, more preferably 1 or more, may be used. Molybdenum (Mo), tungsten (W), silver (Ag), or an alloy of the foregoing with another metal may be used, for example. The metal material to be used as a material of the light source may be a linear member disposed in the pipe, a strip-shaped plate disposed in the pipe, a metal material applied inside the pipe, or a metal material embedded in part of the pipe, for example. The atmospheric gas is preferably contained in a vessel at least having a transparent window through which light is output. Alternatively, the atmospheric gas may be used under reflux through the vessel. The atmospheric gas is preferably an inert gas such as He, Ne, Ar, Kr, Xe, or Rn. In particular, He and Ne are most preferable because they provide high efficiency of secondary electron emission from the metals. The pipes preferably have a diameter of 1 mm or less because high density plasma can be stably confined in such micro hollow pipes and a point light source is obtained. Although the term “micro refers to a size of about 1 mm or less, micro hollow pipes in the present invention include pipes with a diameter of 1 cm or less. Micro hollow pipes most preferably have a diameter of 1 mm or less.

In an invention according to Claim 2, the anode plate includes a metal plate having windows at positions corresponding to opening ends of the micro hollow pipes. The anode plate is preferably made of copper or a copper alloy.

In an invention according to Claim 3, the anode plate includes a metal mesh. The metal mesh is preferably made of copper or a copper alloy.

In an invention according to Claim 4, the metal material includes a wire.

An invention according to Claim 5 provides a multi micro hollow cathode light source that generates micro hollow plasma as a light source in a transparent vessel filled with atmospheric gas, including a cathode plate made of copper or a copper alloy; an insulating plate; an anode plate placed on the cathode plate with the insulating plate therebetween; a plurality of holes with a diameter of 1 cm or less, the plurality of holes extending through the cathode plate, the insulating plate, and the anode plate; a metal plate provided at an opening of the hole of the cathode plate, the metal plate being made of an element corresponding to a desired light-source spectrum; and atmospheric gas. In Claim 5, the term “micro” has the same meaning as that given in Claim 1. The holes preferably have a diameter of 1 mm or less because this permits confinement of plasma at a high density and a point light source is obtained.

An invention according to Claim 6 provides the multi micro hollow cathode light source according to Claim 5 in which the atmospheric gas includes helium.

### ADVANTAGES

The invention according to Claim 1 achieves confinement of high density plasma in micro hollow pipes with a diameter of 1 cm or less because the pipes are made of copper or a copper alloy. This is achieved probably because use of copper or a copper alloy as the electrode increases the number of plasma ions being generated. Thus, high density plasma is generated in the pipes at a high pressure of about 0.1 atmospheres even with a diameter of 1 mm or less. In particular, use of the pipes with a diameter of 1 mm or less provides a point light source as the light emission source and also reduces power consumption. An increase in sputtering efficiency by increasing the density of plasma with micro hollow pipes made of copper and placement of metal materials in the pipes permits generation of plasma, at a high density, of elements forming the metal materials. Use of helium as the atmospheric gas according to the invention of Claim 6 increases the density of electrons emitted by secondary electron emission, generating plasma at a high density in the micro hollow pipes. In particular, use of the pipes with a diameter of 1 mm or less provides necessary plasma of metal atoms even at an internal pressure of about 0.1 atmospheres. This reduces Doppler broadening, decreasing the width of a line spectrum. Use of a point light source increases the amount of light that is focused onto a spectroscope.

According to the invention of Claim 5, an anode plate, an insulating plate, and a cathode plate made of copper or a copper alloy are stacked; holes with a diameter of 1 cm or less are formed to extend through the stacked plates; and a metal plate formed of an element corresponding to a desired spectrum is disposed at the opening of the hole. This configuration permits operations, as with those in Claim 1, whereby the hole functions as a micro hollow pipe so that high density plasma is confined in the hole and the opening of the hole. Since a metal plate made of an element corresponding to a desired light-source spectrum is provided at the opening of the hole of the cathode plate, the metal plate is sputtered, thereby forming high density plasma of the metal element. This provides light with a desired spectrum, offering the same advantages as Claim 1. In particular, as with the description in Claim 1, use of a hole with a diameter of 1 mm or less provides necessary plasma of metal atoms even at an internal pressure of about 0.1 atmospheres. This reduces Doppler broadening, decreasing the width of a line spectrum. Use of a point source increases the amount of light that is focused onto a spectroscope. Also, power consumption is reduced.

### BRIEF DESCRIPTION OF DRAWINGS

FIG. 1 is a side view showing the configuration of a simultaneous multielement emission light source according to EXAMPLE 1, which is specifically described, of the present invention.

FIG. 2 is a perspective view showing the arrangements of metal wires in micro hollow pipes in EXAMPLE 1.

FIG. 3 is a measurement graph showing an emission spectrum of a micro hollow pipe made of copper in EXAMPLE 1.

FIG. 4 is a measurement graph showing the relationship between emission intensity and the internal pressure of the lamp and the current in the micro hollow pipe made of copper in EXAMPLE 1.

FIG. 5 is a measurement graph showing an emission spectrum of a micro hollow copper pipe in which Fe wires are inserted in EXAMPLE 1.

FIG. 6 is a measurement graph showing the relationship between emission intensity and the internal pressure of the lamp and the current in the micro hollow copper pipe in which Fe wires are inserted in EXAMPLE 1.

FIG. 7 is a measurement graph showing an emission spectrum of a micro hollow copper pipe in which Mo wires are inserted in EXAMPLE 1.

FIG. 8 is a measurement graph showing the relationship between emission intensity and the internal pressure of the lamp and the current in the micro hollow copper pipe in which Mo wires are inserted in EXAMPLE 1.

FIG. 9 is a measurement graph showing an emission spectrum of a micro hollow copper pipe in which Brass wires are inserted in EXAMPLE 1.

FIG. 10 is a measurement graph showing the relationship between emission intensity and the internal pressure of the lamp and the current in the micro hollow copper pipe in which Brass wires are inserted in EXAMPLE 1.

FIG. 11 is a measurement graph showing an emission spectrum of a micro hollow copper pipe in which SUS wires are inserted in EXAMPLE 1.

FIG. 12 is a measurement graph showing the relationship between emission intensity of an Fe emission spectrum and the internal pressure of the lamp and the current in the micro hollow copper pipe in which SUS wires are inserted in EXAMPLE 1.

FIG. 13 is a measurement graph showing the relationship between emission intensity of a Cr emission spectrum and the internal pressure of the lamp and the current in the micro hollow copper pipe in which the SUS wires are inserted in EXAMPLE 1.

FIG. 14 is a measurement graph showing an emission spectrum of micro hollow copper pipes in which Fe, Mo, and Brass wires are respectively inserted in EXAMPLE 1.

FIG. 15 is a measurement graph showing an emission spectrum of a micro hollow copper pipe in which Fe wires are inserted when Fe, Mo, and Brass wires are respectively inserted in the micro hollow copper pipes in EXAMPLE 1.

FIG. 16 is a measurement graph showing an emission spectrum of a micro hollow copper pipe in which Mo wires are inserted when Fe, Mo, and Brass wires are respectively inserted in the micro hollow copper pipes in EXAMPLE 1.

FIG. 17 is a measurement graph showing an emission spectrum of a micro hollow copper pipe in which Brass wires are inserted when Fe, Mo, and Brass wires are respectively inserted in the micro hollow copper pipes in EXAMPLE 1.

FIG. 18 is a schematic view showing the relationship among a cathode plate, an insulating plate, an anode plate, and holes in a simultaneous multielement emission light source according to EXAMPLE 2.

FIG. 19 is a schematic view showing the relationship among the cathode plate, the insulating plate, the anode plate, and metal plates for obtaining desired spectra in the simultaneous multielement emission light source according to EXAMPLE 2.

FIG. 20 is a schematic view of a simultaneous multielement absorption spectrometer according to EXAMPLE 3, the spectrometer being used for measuring the density of elements in plasma in the sputtering device.

FIG. 21 is a measurement graph showing measurement results of simultaneous absorption spectrometry in plasma generated by simultaneously sputtering Cu and Mo, the results being measured with the apparatus according to EXAMPLE 3.

FIG. 22 is a schematic view of a simultaneous multielement absorption spectrometer according to EXAMPLE 4, the spectrometer being used for measuring the density of elements in micro plasma.

### REFERENCE NUMERALS

11 MICRO HOLLOW CATHODE PIPE

12 OPENING

14 METAL WIRE

20 CATHODE HOLDER

30 ANODE HOLDER

32 ANODE MESH

33 INSULATING SPACER

40 GLASS VESSEL

51 CATHODE PLATE

60 ANODE PLATE

62 INSULATING PLATE

52 HOLE

58 MULTI MICRO HOLLOW CATHODE LIGHT SOURCE

71 LASER

78 ABLATION PLASMA

### BEST MODES FOR CARRYING OUT THE INVENTION

Hereinafter, the present invention is specifically described on the basis of EXAMPLEs. However, the present invention is not restricted to the following EXAMPLEs.

### Example 1

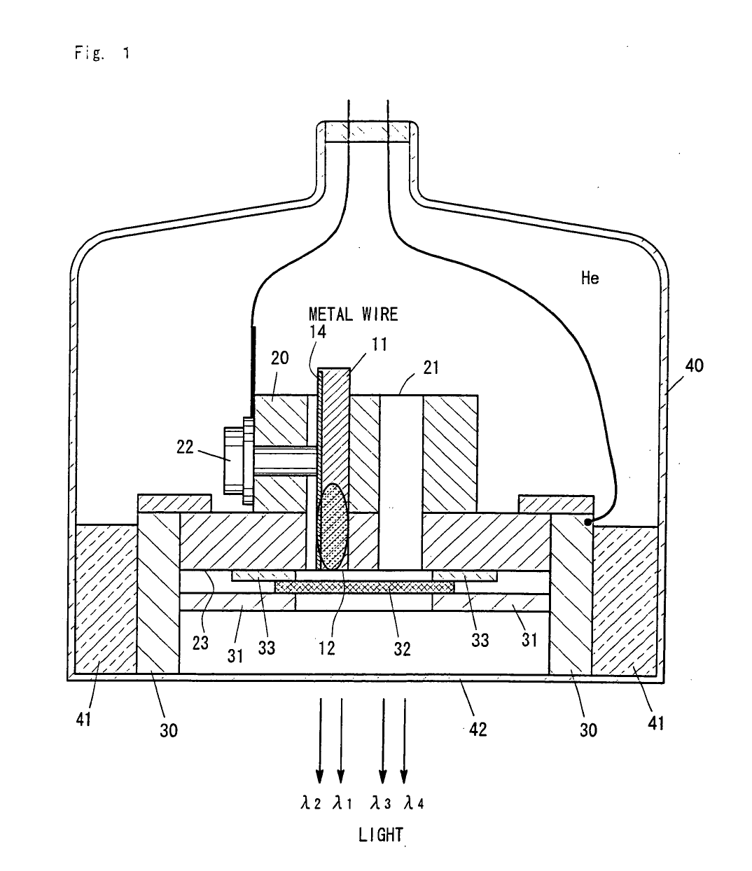

FIG. 1 is a side view showing the configuration of the present device. Micro hollow pipes 11 are made of copper and have an outer diameter of 1 mm, an inner diameter of 0.85 mm, and a length of 20 mm. Four micro hollow pipes are used in EXAMPLE 1. A cathode holder 20, which is made of synthetic quartz and has insulation properties, has holes 21 located at four places. The four micro hollow pipes 11 are inserted into the holes 21 and fastened with screws 22 to the cathode holder 20. The micro hollow pipes 11 are placed such that the end faces of openings 12 of the micro hollow pipes 11 are coplanar with the end face of the cathode holder 20. An anode mesh 32 is provided on a planar portion 31 of an anode holder 30, which is made of metal. An insulating spacer 33, which is a ring-shaped member made of ceramic, is disposed between the anode mesh 32 and an end face 23 of the cathode holder 20. The distance between the anode mesh 32 and the openings 12 of the micro hollow pipes 11 is set at 0.16 mm. The anode mesh 32 is a copper mesh having a wire diameter of 0.11 mm and an open area ratio of 32.23%.

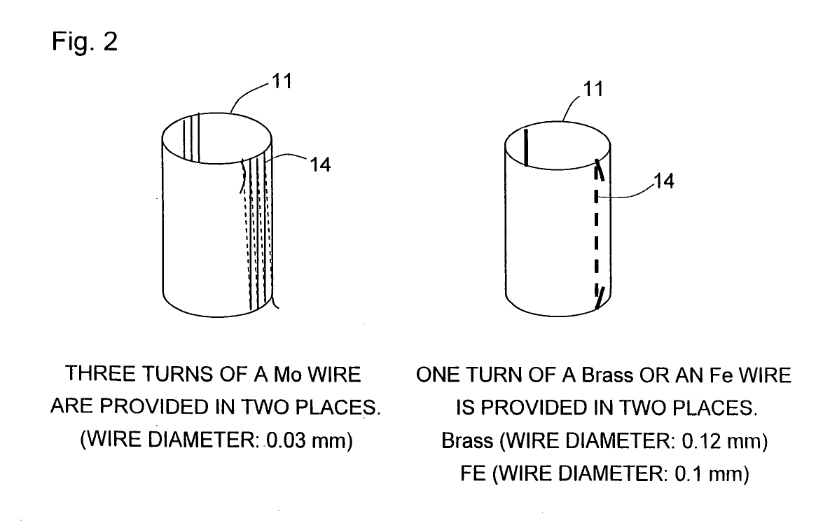

Referring to FIG. 2, several turns of metal wires 14 are provided on the micro hollow pipes 11 in the axis direction such that the metal wires 14 pass at least once through the inside of the micro hollow pipes 11.

The screws 22 are kept at ground potential. The anode holder 30 is subjected to a positive voltage. The anode holder 30 is fixed in a transparent glass vessel 40 with a retention ring 41, which is a ring-shaped member made of heat-resistant rubber, whereby the entirety of the device is fixed in the glass vessel 40. Helium gas is enclosed in the glass vessel 40. Light is output through a light output surface 42, which faces the openings 12 of the micro hollow pipes 11 in the glass vessel 40. The resulting light has desired spectra of four types corresponding to the four micro hollow pipes 11.

The metal wires 14 were wires of four types: Fe, Mo, Brass (Zn: 35%, Cu: 65%), and SUS (Cr: 18-20%, Ni: 8-11%, Fe: 74-69%). Light is output through the light output surface 42, which faces the openings 12 of the micro hollow pipes 11.

Next, measurement results in terms of emission spectra with the light source are described.

The pressure in the glass vessel 40 was changed from 0.01 to 0.1 MPa. The current was changed from 15 to 50 mA.

First, the dependence of emission intensity on pressure and current when the micro hollow pipe 11 without the metal wires 14 was used was measured. The micro hollow pipe 11 was made of copper and had an outer diameter of 1 mm, an inner diameter of 0.85 mm, and a length of 20 mm. The measurement was performed with the electrode distance between the micro hollow pipe 11 and the anode mesh 32 being 0.16 mm. The internal pressure in the glass vessel 40 was changed from 0.1 to 0.01 MPa. The current was changed from 15 to 50 mA. When the current exceeded 50 mA, the micro hollow pipe 11 reached a high temperature and hence melted and adhered to the cathode holder 20, causing no discharge between the micro hollow pipe 11 and the anode mesh 32. When the current was 15 mA or less, discharge was not easily maintained.

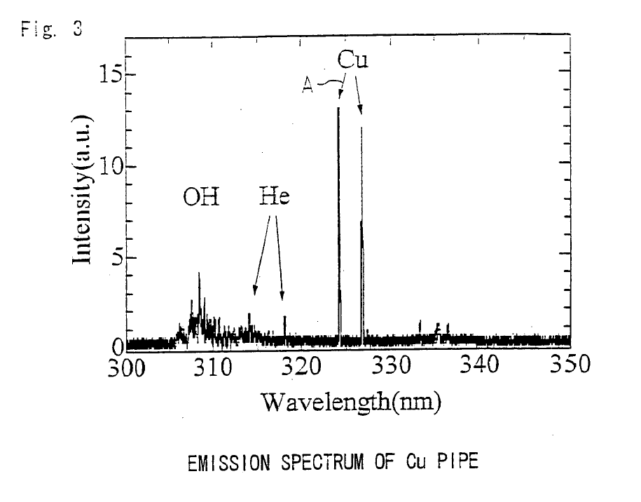

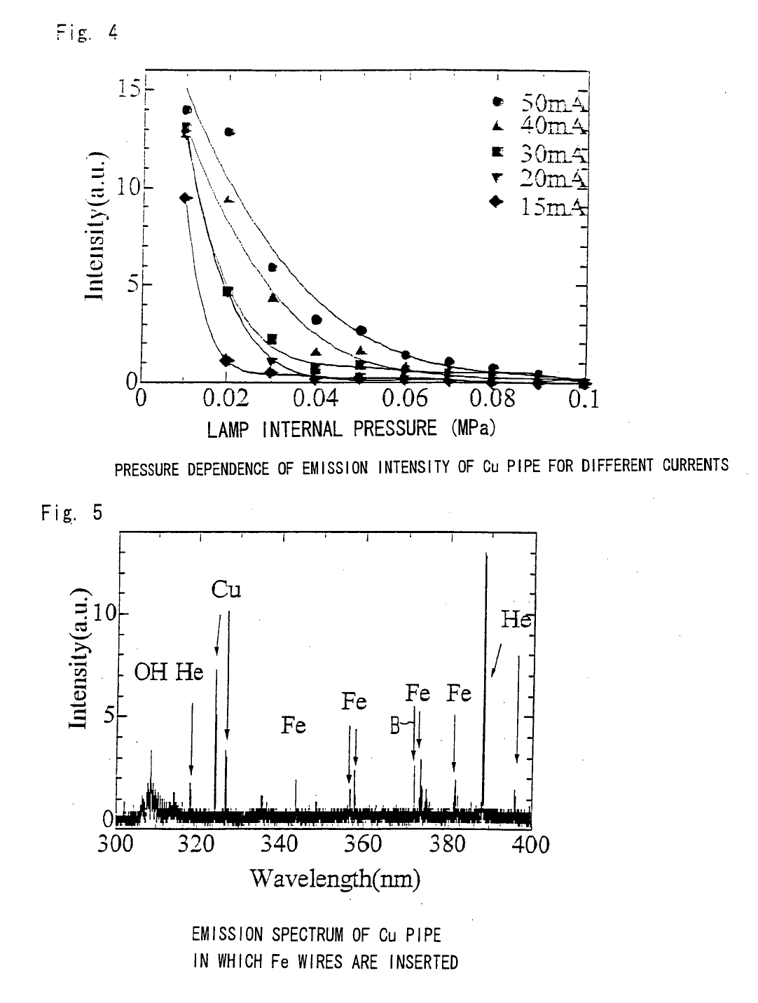

FIG. 3 shows an emission spectrum at an internal pressure of 0.01 MPa and at a current of 30 mA. FIG. 4 shows the dependence of emission intensity on pressure for different currents. Arrow indicated by A in FIG. 3 represents an emission line whose emission intensity was measured. The measured emission line was at 324.754 nm (²S_{1/2}—²P⁰_{3/2}), which is generally used as an analytical line in commercially available copper hollow cathode lamps.

FIG. 4 indicates that the emission intensity increases as the internal pressure of the lamp decreases and the current increases. This is probably because a larger current provides a higher plasma density in the plasma and a decrease in the internal pressure of the lamp facilitates introduction of the cathode metal atoms (copper atoms in the micro hollow pipe 11), which are sputtered by ions in the plasma, into the plasma. FIG. 4 indicates that the emission sharply increases at an internal pressure of the lamp of 0.03 MPa or less. In summary, the internal pressure of the lamp is preferably 0.03 MPa or less and the current is preferably 30 mA or more.

Second, experimental results in the case where Fe wires were disposed in the micro hollow pipe 11 are described. The micro hollow pipe 11 in which Fe wires were inserted were used for discharging and the resulting emission spectrum was measured. The micro hollow pipe 11 had the same dimensions as described above. The Fe wires had a wire diameter of 0.1 mm. Insertion of the Fe wires into the hole of the micro hollow pipe 11 is expected to provide simultaneous emission with spectra unique to Cu and Fe. The current and the internal pressure were changed in the same ranges as those described above. The measured emission line was at 371.993 nm (⁵D₄-⁵F⁰₅), which is used as an analytical line. FIG. 5 shows an emission spectrum at an internal pressure of 0.01 MPa and at a current of 30 mA. FIG. 6 shows the dependence of emission intensity on pressure for different currents.

FIG. 6 indicates that the emission intensity increases as the internal pressure of the lamp decreases. This is, as with the case using the micro hollow pipe 11 without any wire, probably because a decrease in the internal pressure of the lamp facilitated introduction of the cathode metal atoms (Cu in the micro hollow pipe 11 and Fe in the metal wires 14), which were sputtered, into the plasma. There was no significant difference between using 15 mA and 20 mA. This is probably because an electron density sufficient to provide emission was not achieved at a current of 20 mA or less. There was no significant difference among using 50 mA, 40 mA, and 30 mA from 0.1 to 0.03 MPa while the emission intensity increases as the current increases at 0.03 MPa or less. This is probably because atoms forming the cathode were sufficiently sputtered at 30 mA or more and the sputtered metal atoms were more easily introduced in the plasma as the internal pressure of the lamp decreased. Thus, the micro hollow copper pipes 11 are preferably used for discharging at 0.03 MPa or less and at a current of 30 mA or more.

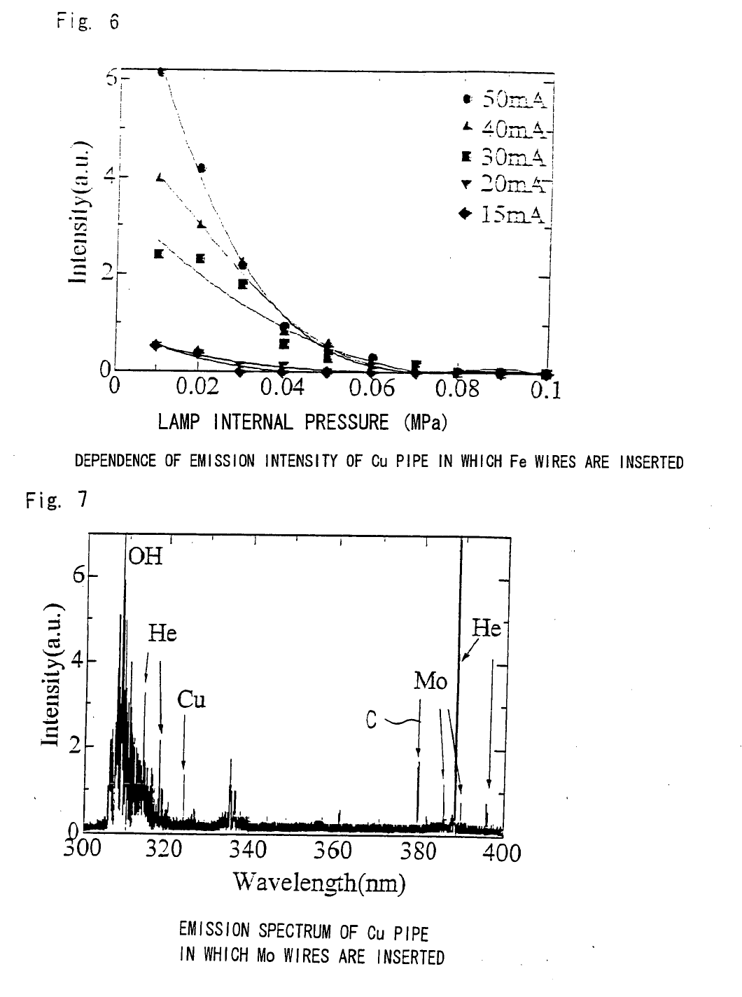

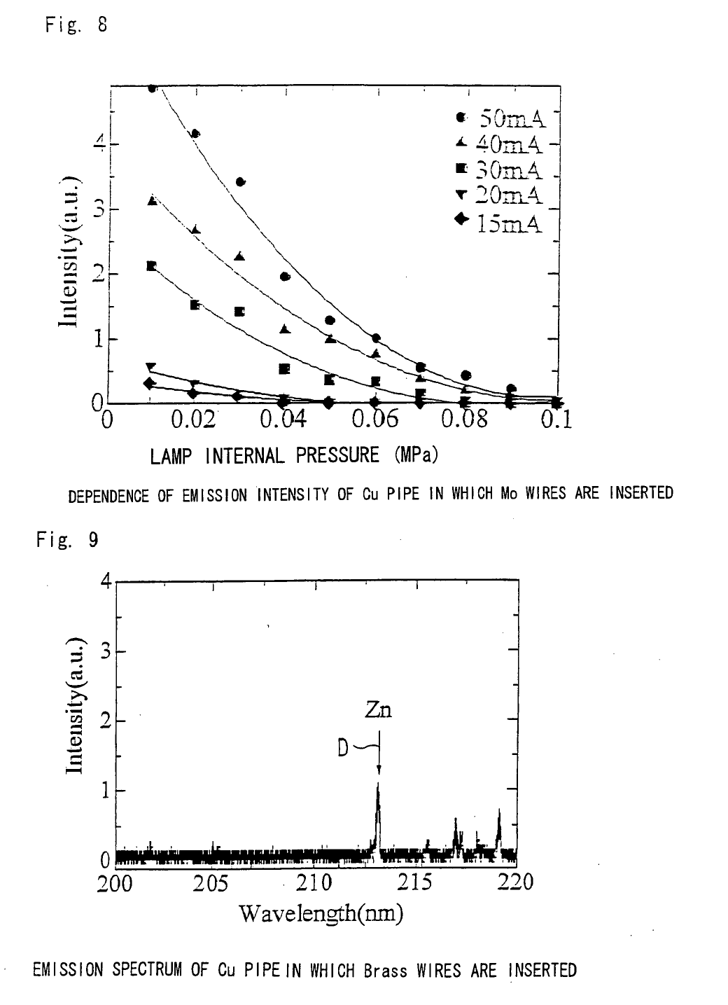

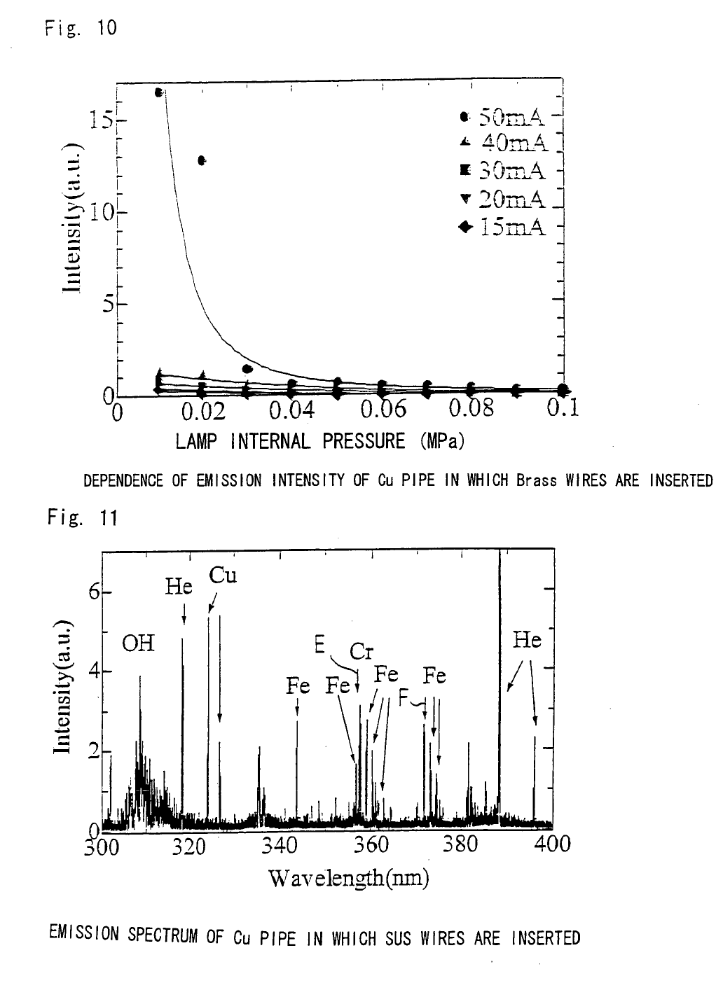

Next, experimental results in the case where Mo wires were disposed in the micro hollow pipe 11 are described. The micro hollow pipe 11 had the same dimensions as described above. The Mo wires 14 had a wire diameter of 0.03 mm. Referring to FIG. 2, since the Mo wires had a very small wire diameter, three turns of the Mo wires were provided about the micro hollow pipe 11 to increase the area of the Mo wires to be sputtered. The measurement conditions of an emission spectrum were the same as those for the micro hollow pipe 11 without any wire. FIG. 7 shows an emission spectrum at an internal pressure of 0.01 MPa and at a current of 30 mA. Emission lines at 313.259 nm (⁷S₃—⁷P⁰₄) and 320.884 nm (⁷S₃-⁷D⁰₂) are used as analytical lines for commercially available Mo hollow cathode lamps. However, the analytical lines were not recognized in this experiment. This is because the analytical lines have emission intensities smaller than those of the other emission lines of Mo and they overlap the emission lines of OH and He. Thus, the dependence of emission intensity of a line at 379.825 nm (⁷S₃—⁷P⁰₄), which is one of the resonance lines of Mo, was measured in this experiment. FIG. 8 shows the dependence of emission intensity of the spectrum on pressure at different currents.

FIG. 8 indicates that the emission intensity generally increases as the internal pressure of the lamp decreases and the current increases. Observation after the discharging revealed that the discharging damaged and broke a part of the Mo wires, which had a small wire diameter. In view of the results, the current is preferably decreased as much as possible while the wire diameter is preferably increased. On the basis of the result that large emission intensities were observed at 0.03 MPa or less, the internal pressure is preferably 0.03 MPa or less and the current is preferably 30 mA or 40 mA when the micro hollow pipe 11 in which Mo wires are inserted is used for discharging.

Next, the micro hollow copper pipe 11 in which the Brass wires 14 were inserted was used for discharging and the resulting emission spectrum was measured. The micro hollow pipe 11 had the same dimensions as described above. The Brass wires had a wire diameter of 0.12 mm. The Brass wires were made of an alloy containing 65% Cu and 35% Zn. Insertion of the Brass wires into the hole of the micro hollow pipe 11 is expected to cause Zn contained in the Brass to emit light. The internal pressure and the current in terms of measurement of the spectrum and emission intensity were changed in the same ranges as those described above. FIG. 9 shows an emission spectrum at an internal pressure of 0.01 MPa and at a current of 30 mA. The emission line whose emission intensity was measured was at 213.857 nm (¹S₀⁻¹P⁰₀), which is used as an analytical line for Zn hollow cathode lamps. FIG. 10 shows the dependence of emission intensity of the spectrum on pressure for different currents.

The emission intensity generally increases as the internal pressure of the lamp decreases. The emission intensity sharply increases at 0.02 MPa or less at 50 mA. Although the emission intensity also increases as the current increases at currents other than 50 mA, the emission intensity is generally lower than those of the other metal wires at the currents. This is because the Brass had a low Zn content (35%), and hence there were not enough sputtered metal atoms for achieving strong emission at 40 mA or less. In summary, a larger current is preferable to cause Zn to emit light by discharging through inserted Brass wires.

Next, the micro hollow pipe 11 in which the SUS wires 14 were inserted was used for discharging and the resulting emission spectrum was measured. The micro hollow pipe 11 had the same dimensions as described above. The SUS wires had a wire diameter of 0.02 mm. The SUS wires used in this experiment were made of an alloy containing 18-20% Cr, 8-11% Ni, and 74-69% Fe. As with the Mo wires, the SUS wires used in this experiment had a very small wire diameter of 0.02 mm. For this reason, as shown in FIG. 2, three turns of the SUS wires were provided around the micro hollow copper pipe 11. Insertion of the SUS wires into the micro hollow pipe 11 is expected to cause Cr, Ni, and Fe contained in the SUS wires to emit light. The current and the internal pressure of the lamp were changed in the same ranges as those described above.

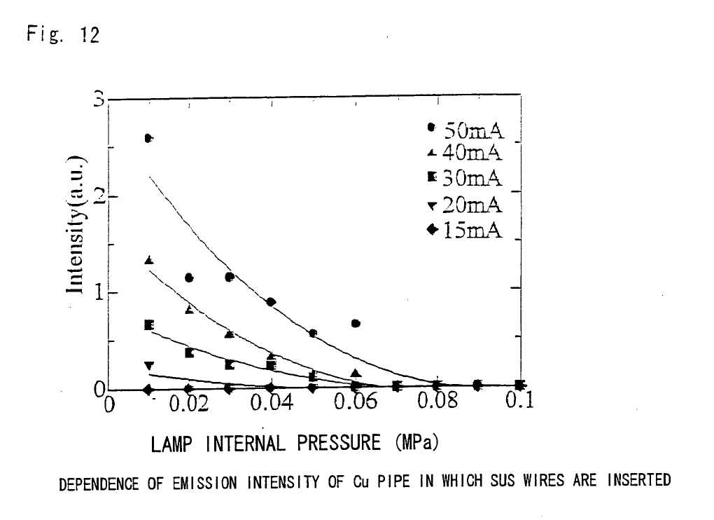

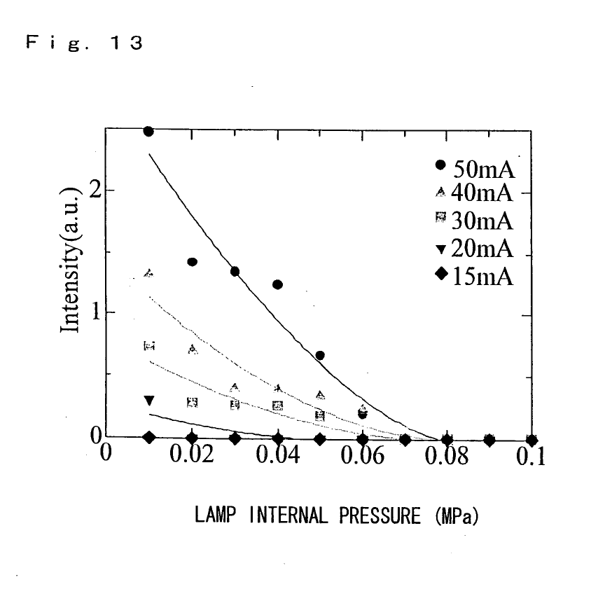

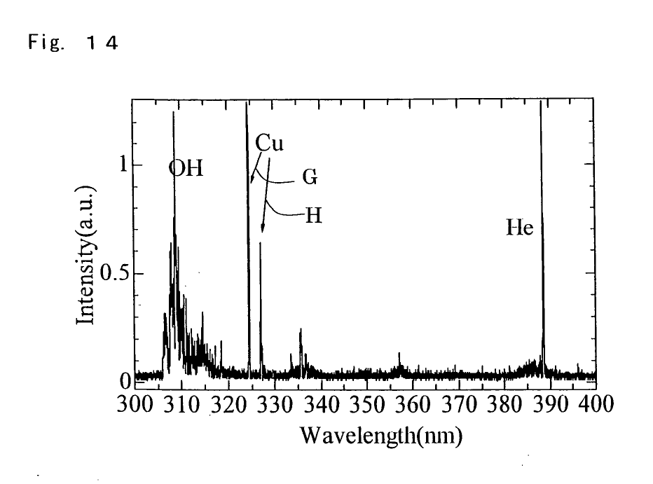

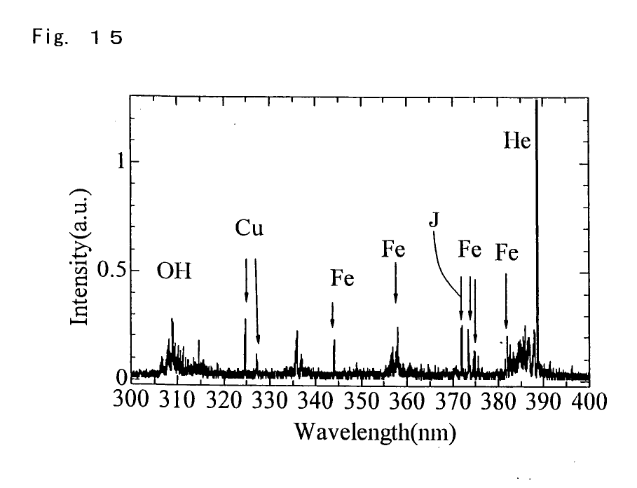

FIG. 11 shows an emission spectrum at 0.01 MPa and at 30 mA. The Ni analytical line could not be obtained in this experiment. This is probably because the Ni content of the SUS was low. Thus, the dependence of emission intensity of Fe and Cr on pressure was measured. For Fe, a line at 371.993 nm (⁵D₄-⁵F⁰₅), which is used as an analytical line for commercially available Fe hollow cathode lamps, was measured. For Cr, a line at 357.868 nm (⁷S₃—⁷P⁰₄), which is used as an analytical line for Cr hollow cathode lamps, was measured. FIG. 12 shows the dependence of emission intensity of Fe on pressure for different currents. FIG. 13 shows the dependence of emission intensity of Cr on pressure for different currents.

FIG. 12 indicates that the intensity of Fe emission generally increases as the internal pressure of the lamp decreases. No emission was observed at a current of 15 mA. However, at 20 mA or more, the emission intensity increased as the current increased and the lamp internal pressure decreased. This is because the plasma density increased with the current, thereby increasing sputtering efficiency while introduction of sputtered atoms into the plasma was facilitated as the internal pressure of the lamp decreased. FIG. 13 indicates that no Cr emission was observed at 15 mA as with the case of Fe. However, at 20 mA or more, the emission intensity increased as the current increased and the lamp internal pressure decreased. The reason for this is probably the same as that in the Fe emission.

Observation of the electrode after the discharging revealed that the discharging damaged and broke a part of the SUS wires, which had a small wire diameter of 0.02 mm. In view of this result, the current needs to be decreased as much as possible while the wire diameter needs to be increased. In view of the emission characteristics of Fe and Cr, the internal pressure of the lamp is preferably decreased for obtaining emission for Fe and Cr by discharging with SUS wires inserted. To increase a current, SUS wires with a larger wire diameter are preferably used.

In summary, the experimental results have revealed that the emission intensity increases by increasing the current or decreasing the internal pressure of the lamp. The emission intensity sharply increases at an internal pressure of the lamp of 0.04 to 0.03 MPa. Strong emission was obtained at a current of 30 mA or more. In view of such results, the internal pressure of the lamp is preferably 0.03 MPa or less and the current for each of the electrodes is preferably 30 mA or more when a cathode having the micro hollow pipes 11 in which metal wires are inserted is used for discharging. As for the cases where the alloy wires were used, the emission intensities of Zn in the Brass wires and Fe and Cr in the SUS wires were lower than those of Cu in the micro hollow pipes 11 and Fe in the Fe wires. This is probably because the content of each element in the alloy wires was less than the Cu content of the micro hollow pipes 11 or the Fe content of the Fe wires. The Fe wires had a wire diameter of 0.1 mm and the Brass wires had a wire diameter of 0.12 mm. These wires remained unbroken after the discharging and emitted light was easily identifiable. Consequently, the wires preferably have a wire diameter of 0.1 mm or more.

Next, four micro hollow pipes 11 were respectively placed in the four holes 21 of the cathode holder 20. The micro hollow pipes 11 were a copper pipe without any wire, a copper pipe with Fe wires inserted therein, a copper pipe with Mo wires inserted therein, and a copper pipe with Brass wires inserted therein. All the micro hollow pipes 11 had an inner diameter of 0.85 mm. Helium gas was enclosed. The anode mesh 32 was made of copper. The electrode distance between the openings 12 of the micro hollow pipes 11 and the anode mesh 32 was 160 μm. Emission spectra were measured with the light source having such a configuration. A point emission was observed separately at each of the openings 12 of the four micro hollow pipes 11.

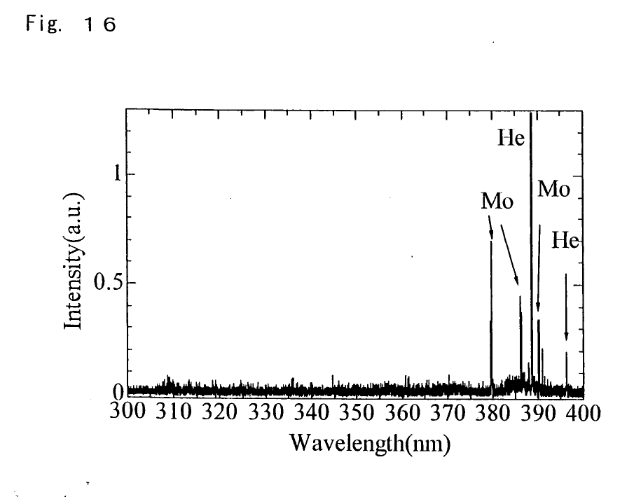

FIG. 14 shows an emission spectrum of the micro hollow pipe 11 without any metal wire at a lamp internal pressure of 0.02 MPa and at a power supply current, which is fed to the entirety of the four micro hollow pipes 11, of 71 mA. FIG. 14 shows emissions at 324.754 nm (²S_{1/2}—²P⁰_{3/2}) and at 327.395 nm (²S_{1/2}—²P⁰_{1/2}), which are analytical lines for Cu. FIG. 14 also shows an emission of He, which was the atmospheric gas, at 388.865 nm (³S₁—³P⁰₃) and emissions of OH derived from moisture attached to the inside of the lamp from 305 to 318 nm. In summary, simultaneous emission of the four pipes provided the analytical lines for Cu from the copper pipe.

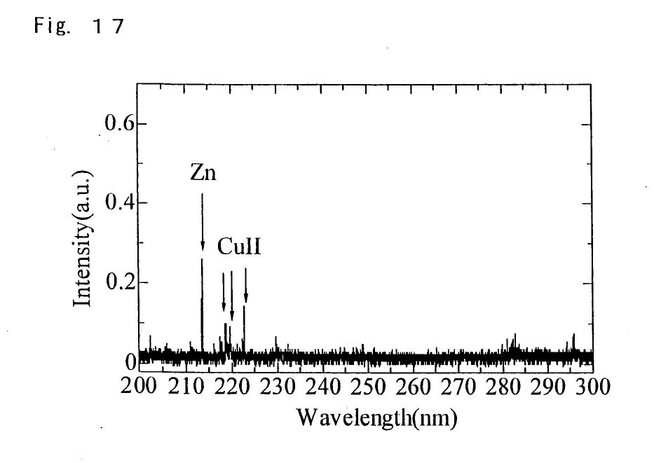

FIG. 15 shows an emission spectrum of the micro hollow pipe 11 in which Fe wires were inserted. The Fe wires had a wire diameter of 0.1 mm. Emission lines at 324.754 nm (²S_{1/2}—²P⁰_{3/2}) and at 327.395 nm (²S_{1/2}—²P⁰_{1/2}), which are analytical lines for Cu, were observed. An emission at 371.993 nm (⁵D₄-⁵F⁰₅), which corresponds to an analytical line for Fe, was also observed. In addition, emissions of Fe at 344.061 nm (⁵D₄-⁵P⁰₃), 357.010 nm (⁵F₄-³G⁰₅), 358.119 nm (⁵F₅-⁵G⁰₆), 373.713 nm (⁵D₃-⁵F⁰₅), 374.948 nm (⁵F₄—⁵F⁰₄), and 382.043 nm (⁵F₅-⁵D⁰₄) were observed. In summary, when the four pipes were simultaneously used for discharging, the micro hollow pipe in which Fe wires were inserted provided the analytical lines for Fe.

FIG. 16 shows an emission spectrum of the micro hollow pipe 11 in which Mo wires were inserted. The Mo wires had a wire diameter of 0.03 mm. Since the Mo wires had a smaller wire diameter than the Fe wires, three turns of the Mo wires were provided around the micro hollow pipe 11. FIG. 16 indicates that emission spectra of Mo resonance lines at 379.825 nm (⁷S₃—⁷P⁰₄), 386.410 nm (⁷S₃—⁷P⁰₃), and 390.295 nm ⁷S₃—⁷P⁰₂) were obtained. However, emissions at 313.259 nm (⁷S₃—⁷P⁰₄) and 320.884 nm (⁷S₃-⁷D⁰₂), which are analytical lines used for atomic absorption spectrometry, were not obtained. Emissions at these spectra would have been obtained by increasing the wire diameter and generating high density plasma.

FIG. 17 shows an emission spectrum of the micro hollow pipe 11 in which Brass wires were inserted. The Brass wires contained 65% Cu and 35% Zn and had a wire diameter of 0.12 mm. FIG. 17 indicates that the Zn analytical line was observed at 212.857 nm (¹S₃—¹P⁰₁). However, the emission of Zn was weaker than the emissions of the other wires. This is probably because the Zn content of the Brass wires was 35%, which was smaller than the contents of the other metals.

In summary, simultaneous emission from the four micro hollow pipes 11 was achieved and spectra unique to Cu, Fe, Mo, and Zn could be obtained. For Cu, Fe, and Zn, emission lines that can be used as analytical lines were observed. Although there was probably emission of light at the emission line of Mo, it overlapped with the emission lines of OH.

Metal wires were inserted in the micro hollow pipes 11 in EXAMPLE 1. Alternatively, metal plates may be used. Alternatively, a metal other than the material of the micro hollow pipe 11 and with which a desired spectrum can be obtained may be embedded in a part of the wall of the micro hollow pipe 11 or a part of the wall of the micro hollow pipe 11 may be formed of an alloy for obtaining a desired spectrum. Alternatively, such a metal may be applied to the micro hollow pipe 11. In summary, emission of a metal other than Cu is obtained in EXAMPLE 1 by sputtering the metal with high density plasma generated from Cu. In summary, preferred current is in the range from 10 to 50 mA. Preferred internal pressure is in the range from 0.01 to 0.1 MPa. The micro hollow pipe 11 preferably has a diameter of 2 mm or less, more preferably 1 mm or less, and more preferably in the range from 0.2 to 1 mm. The metal wires and the like preferably have such a thickness that they can be inserted into the micro hollow pipe 11 and can be sputtered in the pipe. For example, the thickness is ½ to 1/20 of the diameter of the pipe, and preferably ½ to 1/10 of the diameter of the pipe. Thicker metal wires generally tend to generate high density plasma of the metal element corresponding to the wires as long as the wires can be used to generate plasma. Alternatively, such a metal may be used as a metal strip, or such a metal may be embedded in a part of the wall of the micro hollow pipe 11. Alternatively, such a metal may be applied to the inner wall of the pipe. In addition to copper and a copper alloy, the micro hollow pipes 11 may be made of a metal having a high secondary electron emission coefficient such as silver (Ag), a silver alloy, molybdenum (Mo), a molybdenum alloy, tungsten (W), a tungsten alloy, or an alloy of any one of the foregoing metals. These metals may be used in combination with a rare gas such as He or Ne. Such a metal or an alloy preferably has a secondary electron emission coefficient of 0.2 or more, more preferably 1 or more. Simultaneous multielement emission was also observed when an anode plate was used instead of the anode mesh. The anode plate was made of a metal such as copper, had apertures with a diameter equal to the inner diameter of the micro hollow pipes 11, and was arranged such that the apertures were co-axial relative to the micro hollow pipes 11 with an insulating body between the micro hollow pipes 11 and the anode plate.

### Example 2

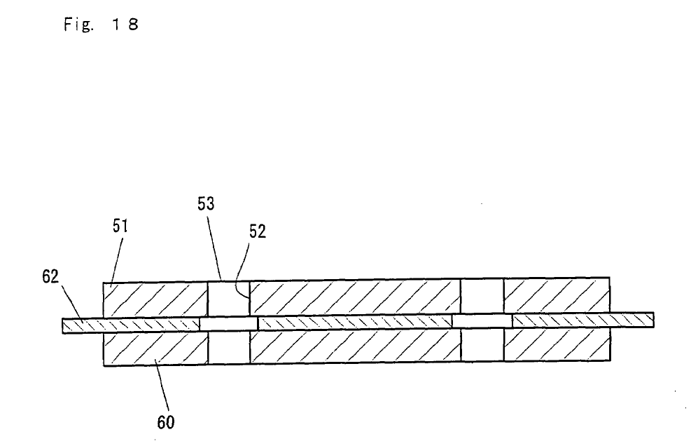

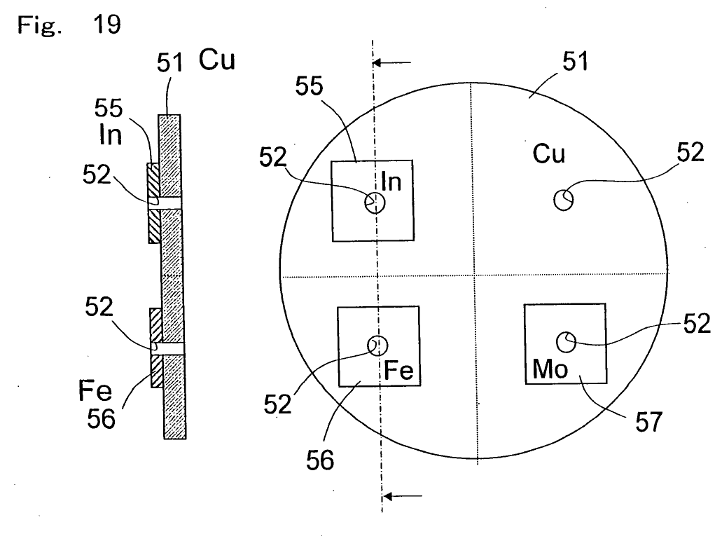

An anode plate and a cathode plate are arranged with an insulating plate therebetween in EXAMPLE 2. Referring to FIG. 18, a cathode plate 51, an insulating plate 62, and an anode plate 60 are stacked. The cathode plate 51 is a circular plate with a diameter of 30 mm and a thickness of 1 mm, and made of copper. The insulating plate 62 is a circular plate with a diameter of 40 mm and a thickness of 0.3 mm. The anode plate 60 is a circular plate with a diameter of 30 mm and a thickness of 1 mm, and made of copper. The laminate has holes 52 at four places. Referring to FIG. 19, an In plate 55, an Fe plate 56, and a Mo plate are provided at three out of four openings 53 of the holes 52 in the cathode plate 51 such that the holes of the plates 55, 56, and 57 are concentric with the holes 52. Each of the metal plates has a thickness of 300 μm.

The laminate is provided on the holder 31 shown in FIG. 1. However, in EXAMPLE 2, the holder 31 in FIG. 1 is a cathode holder and the cathode plate 51 is bonded onto the holder 31. The holder 31 is connected to ground potential. The cathode plate 51 is grounded. The anode plate 60 is subjected to a positive voltage.

The holes 52 have a diameter of 500 μm. The hole of the insulating plate 62 has a diameter of 700 μm, which is slightly larger than those of the holes 52 of the cathode plate 51 and the anode plate 60. This is intended to prevent discharging from melting the insulating plate 62. The atmospheric gas in the glass vessel 40 is helium. The internal pressure was changed in the range from 0.1 to 0.01 MPa. Application of a voltage across the cathode plate 51 and the anode plate 60 causes gaseous atoms contained in the lamp to be ionized, generating plasma. The ions in the plasma are attracted to and impinge on the cathode plate 51 with a negative electric field. The impact of the ions ejects metal atoms or electrons forming the cathode plate 51. The ejected electrons, which are referred to as secondary electrons, promote ionization of new atoms in plasma, generating plasma efficiently. In this way, gaseous atoms contained in plasma being generated are excited and then radiate a spectrum unique to the gas. When the internal pressure of the lamp is decreased, metal atoms having formed the cathode plate 51 and being ejected by ion impact tend to be introduced into plasma. This enables radiation of a spectrum unique to the metal.

Since plasma generated from the cathode plate 51 made of copper has a high plasma density, the plasma is used to simultaneously sputter other metals. This is a core point of EXAMPLE 2. Simultaneous emission from a plurality of metals is achieved by forming a plurality of micro hollows (holes 52) into the cathode plate 51 made of copper and by attaching different metal plates 55, 56, and 57 such that the plates are aligned with the holes 52. The metal plates preferably have a thickness in the range of 100 to 300 μm. The current is preferably from 10 to 50 mA. In this way, simultaneous multielement emission of Cu, Fe, In, and Mo was observed. EXAMPLE 2 uses high density plasma generated from Cu to sputter other metals, providing emissions of the metals. Examples of a material for the cathode plate 51 may include metals having a high secondary electron emission coefficient such as copper, copper alloys, silver, silver alloys, molybdenum, molybdenum alloys, tungsten, and tungsten alloys. These metals may be used in combination with a rare gas such as He or Ne. The metals preferably have a secondary electron emission coefficient of 0.2 or more, more preferably 1 or more. The metal plates 55, 56, and 57 will suffice as long as they are disposed near the holes 52 of the cathode plate 51. The metal plates 55, 56, and 57 may be disposed on the inner side walls of the holes 52, may be embedded in a part of the side walls, or may be coated inside the holes. Such alternatives are the same as those in EXAMPLE 1.

### Example 3

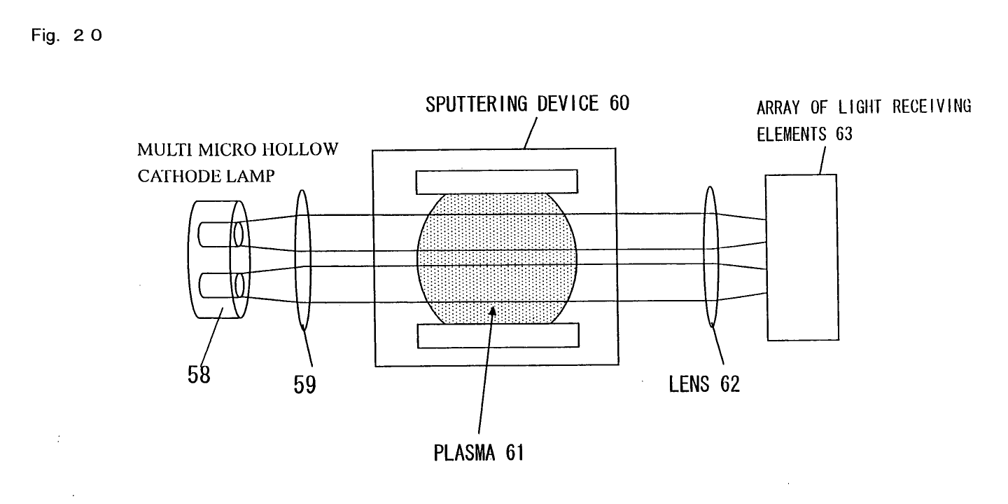

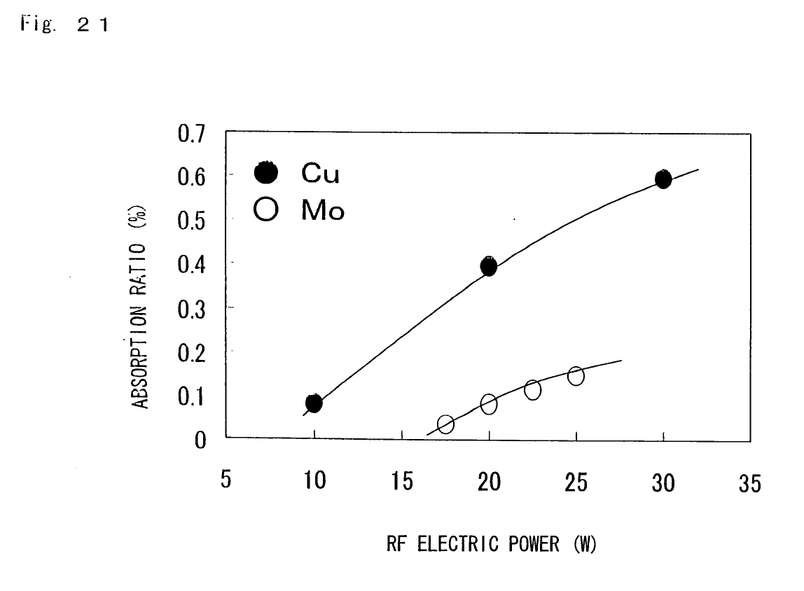

EXAMPLE 3 shows an example of a simultaneous multielement atomic absorption spectrometer that performs simultaneous multielement atomic absorption spectrometry with a multi micro hollow cathode light source. Referring to FIG. 20, beams from elements forming emission sources were collimated with a collimate lens 59, which faced a multi micro hollow cathode light source 58. The beams were then passed through plasma 61, which was to be measured, in a sputtering device 60. Cu and Mo were used as sputtering targets in the sputtering device 60. Plasma simultaneously containing Cu and Mo was generated in the sputtering device 60. The collimated beams that were from the light source and passed through the plasma were condensed on an array 63 of light receiving elements with a condenser lens 62.

FIG. 21 shows results of simultaneously measuring absorption ratios of Cu and Mo, with the optical system, in plasma generated by simultaneously sputtering Cu and Mo in which electric power for the sputtering was changed. Although two elements were measured in EXAMPLE 3, absorption ratios of two or more elements can be measured in a similar manner and densities of two or more elements can be simultaneously measured.

### Example 4

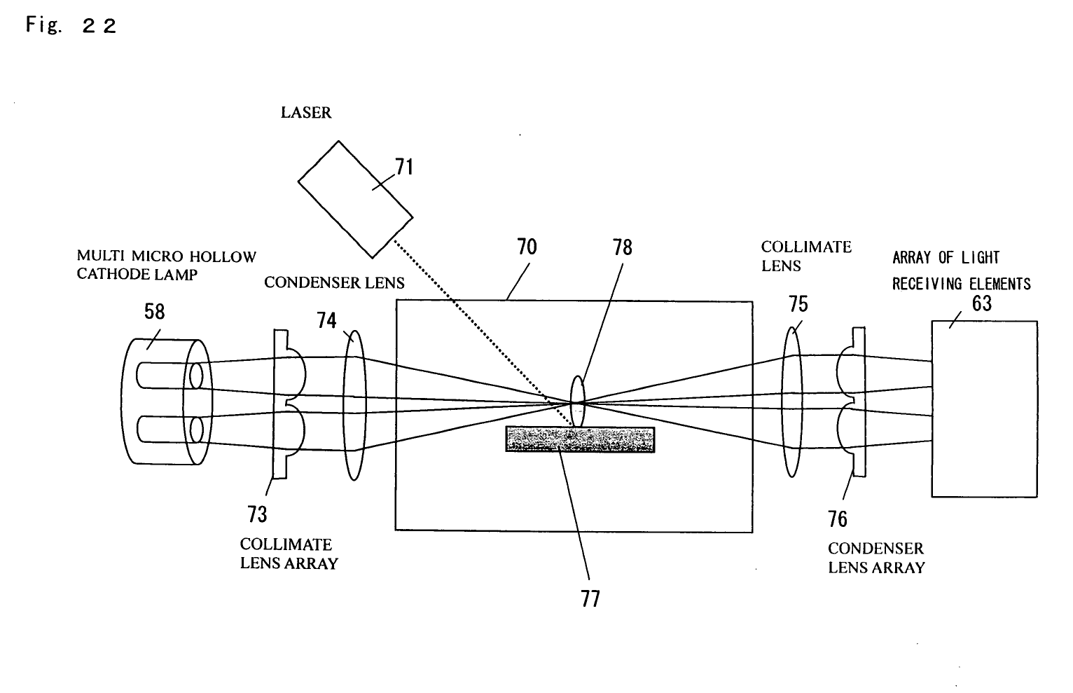

While densities of metal elements in plasma in the sputtering device were measured in EXAMPLE 3, an optical apparatus in FIG. 22 according to EXAMPLE 4 may be provided. A sample 77 is irradiated with a laser 71 to vaporize elements forming the sample, generating ablation plasma 78. Beams from a multi micro hollow cathode light source 58 are collimated with a collimate lens 73 and a condenser lens 74 and applied to the ablation plasma 78. The beams that have passed through the ablation plasma 78 are condensed onto an array 63 of light receiving elements with a collimate lens 75 and a condenser lens array 76. In this way, the intensity of the transmitted beams, which have been absorbed by the ablation plasma 78, is measured. Such a compact apparatus can be provided that simultaneously measures two or more elements at one time in terms of the densities of the elements in plasma, in which the densities vary rapidly in a micro area. Techniques for obtaining vapor of metals (atomization) are not restricted to the examples in FIGS. 20 and 22. Flame, electrical heating, or the like, which is used in typical atomic absorption spectrometry and the like, may also be used.

With such a configuration, emission of Cu, Fe, In, and Mo was observed.

### INDUSTRIAL APPLICABILITY

The present invention is applicable to multielement light sources for atomic absorption spectrometry, which is used for determining metal elements.

1. A multi micro hollow cathode light source that generates micro hollow plasma as a light source in atmospheric gas, comprising:
a plurality of cylindrical micro hollow pipes with a diameter of 1 cm or less that are made of a metal having a high secondary electron emission coefficient such as copper or a copper alloy;
an anode plate provided at ends of the micro hollow pipes with an insulating member between the anode plate and the ends;
a metal material provided in at least one of the micro hollow pipes, the metal material being made of an element corresponding to a desired light-source spectrum; and
atmospheric gas.

2. The multi micro hollow cathode light source according to claim 1, wherein the anode plate includes a metal plate having windows at positions corresponding to opening ends of the micro hollow pipes.

3. The multi micro hollow cathode light source according to claim 1, wherein the anode plate includes a metal mesh.

4. The multi micro hollow cathode light source according to claim 1, wherein the metal material includes a wire.

5. A multi micro hollow cathode light source that generates micro hollow plasma as a light source in atmospheric gas, comprising:
a cathode plate made of copper or a copper alloy;
an insulating plate;
an anode plate placed on the cathode plate with the insulating plate therebetween;
a plurality of holes with a diameter of 1 cm or less, the plurality of holes extending through the cathode plate, the insulating plate, and the anode plate;
a metal plate provided at an opening of at least one of the holes of the cathode plate, the metal plate being made of an element corresponding to a desired light-source spectrum; and
atmospheric gas.

6. The multi micro hollow cathode light source according to claim 1, wherein the atmospheric gas includes helium.

7. A simultaneous multielement atomic absorption spectrometer comprising the multi micro hollow cathode light source according to claim 1.

8. The multi micro hollow cathode light source according to claim 2, wherein the metal material includes a wire.

9. The multi micro hollow cathode light source according to claim 3, wherein the metal material includes a wire.

10. The multi micro hollow cathode light source according to claim 2, wherein the atmospheric gas includes helium.

11. The multi micro hollow cathode light source according to claim 3, wherein the atmospheric gas includes helium.

12. The multi micro hollow cathode light source according to claim 4, wherein the atmospheric gas includes helium.

13. The multi micro hollow cathode light source according to claim 5, wherein the atmospheric gas includes helium.

14. A simultaneous multielement atomic absorption spectrometer comprising the multi micro hollow cathode light source according to claim 5.
